(19) United States
(12) Patent Application Publication
(10) Pub. No.: US 2019/0248544 A1
(43) Pub. Date: Aug. 15, 2019

(54) Collapsible storage box

(71) Applicant: Wei Cheng HU, Taoyuan City (TW)

(72) Inventor: Wei Cheng HU, Taoyuan City (TW)

(21) Appl. No.: 15/892,429

(22) Filed: Feb. 9, 2018

(51) Int. Cl. B65D 21/08; F16B 5/00

(52) U.S. Cl. CPC B65D 21/086; F16B 5/0084

(57) ABSTRACT

A collapsible storage box contains: a bottom plate, a first long plate, a second long plate, and two foldable short plates. Each foldable short plate includes a first connection sheet and a second connection sheet. A front end of the bottom plate retains with multiple first L-shaped hooks on a bottom of the first long plate, multiple first rotary shafts on a rear end of the bottom plate rotatably connect with multiple first retainers on a bottom of the second long plate respectively, a first side of the bottom plate retains with a first flexible hook on a bottom of the first connection sheet of each foldable short plate, and a second side of the bottom plate retains with a second flexible hook on a bottom of the second connection sheet of each foldable short plate. Thereby, the collapsible storage box is expanded and retracted quickly and easily.

### FIELD OF THE INVENTION

The present invention relates to a collapsible storage box which is expanded and retracted quickly and easily.

### BACKGROUND OF THE INVENTION

A conventional collapsible storage box contains a base, four peripheral plates arranged on the base, a cap covered on an opening defined by the base and the four peripheral plates. However, it will occupy a large space as retracting the conventional collapsible storage box.

The present invention has arisen to mitigate and/or obviate the afore-described disadvantages.

### SUMMARY OF THE INVENTION

The primary aspect of the present invention is to provide a collapsible storage box which is expanded and retracted quickly and easily.

Another aspect of the present invention is to provide a collapsible storage box which is retracted in a small size.

To obtain the above aspects, a collapsible storage box provided by the present invention contains: a bottom plate, a first long plate, a second long plate, and two foldable short plates.

Each of the two foldable short plates includes a first connection sheet and a second connection sheet.

A front end of the bottom plate retains with multiple first L-shaped hooks on a bottom of the first long plate, multiple first rotary shafts on a rear end of the bottom plate rotatably connect with multiple first retainers on a bottom of the second long plate respectively, a first side of the bottom plate retains with a first flexible hook on a bottom of the first connection sheet of each foldable short plate, and a second side of the bottom plate retains with a second flexible hook on a bottom of the second connection sheet of each foldable short plate.

The bottom plate includes multiple locking recesses defined on the front end thereof, the multiple first rotary shafts arranged on the rear end of the bottom plate, multiple first notches arranged among the multiple first rotary shafts respectively, and multiple first cutouts formed on the first side and the second sides of the bottom plate.

The first long plate includes multiple second retainers arranged on a first side and a second side thereof individually, multiple second cutouts defined among the multiple second retainers respectively, the multiple first L-shaped hooks formed on the bottom of the first long plate, and multiple second notches defined among the multiple first L-shaped hooks individually.

The second long plate includes two ribs arranged on a first side and a second side thereof individually, multiple third retainers arranged on the two ribs respectively, multiple L-shaped recesses defined among the multiple third retainers individually, and the multiple first retainers formed on the bottom of the second long plate.

Each foldable short plate includes the first connection sheet and the second connection sheet, and the two foldable short plates correspond to each other.

The first connection sheet includes multiple second rotary shafts arranged on a first side thereof, multiple second L-shaped hooks formed among the multiple second rotary shafts respectively, multiple third rotary shafts arranged on a second side of the first connection sheet, multiple third notches defined among the multiple third rotary shafts individually, two fourth notches formed on the bottom of the first connection sheet, the first flexible hook defined between the two fourth notches, a first coupling seat formed on a corner of a top of the first connection sheet adjacent to the second connection sheet, a first indentation defined on a bottom of the first coupling seat, and a first shoulder formed on a front end of the first indentation, wherein the first coupling seat has a U-shaped abutting piece, a slip defined inside the U-shaped abutting piece, an engaging dent formed in the slip.

The second connection sheet includes multiple fourth retainers arranged on a first side thereof adjacent to the second side of the first connection sheet, multiple third L-shaped hooks defined among the multiple fourth retainers individually, multiple fourth rotary shafts arranged on a second side of the second connection sheet, multiple fourth L-shaped hooks formed among the multiple fourth rotary shafts respectively, two fifth notches formed on the bottom of the second connection sheet, the second flexible hook defined between the two fifth notches, a second coupling seat formed on a corner of a top of the second connection sheet adjacent to the first connection sheet, a second indentation defined on a bottom of the second coupling seat, and a second shoulder formed on a front end of the second indentation.

### BRIEF DESCRIPTION OF THE DRAWINGS

FIG. 1 is a perspective view showing the exploded components of a collapsible storage box according to a preferred embodiment of the present invention.

FIG. 2 is a perspective view showing the assembly of the collapsible storage box according to the preferred embodiment of the present invention.

FIG. 3 is a cross sectional view showing the operation of the collapsible storage box according to the preferred embodiment of the present invention.

FIG. 4 is another cross sectional view showing the operation of the collapsible storage box according to the preferred embodiment of the present invention.

FIG. 5 is also another cross sectional view showing the operation of the collapsible storage box according to the preferred embodiment of the present invention.

FIG. 6 is still another cross sectional view showing the operation of the collapsible storage box according to the preferred embodiment of the present invention.

FIG. 7 is another cross sectional view showing the operation of the collapsible storage box according to the preferred embodiment of the present invention.

FIG. 8 is also another cross sectional view showing the operation of the collapsible storage box according to the preferred embodiment of the present invention.

FIG. 9 is still another cross sectional view showing the operation of the collapsible storage box according to the preferred embodiment of the present invention.

### DETAILED DESCRIPTION OF THE FIRST EMBODIMENTS

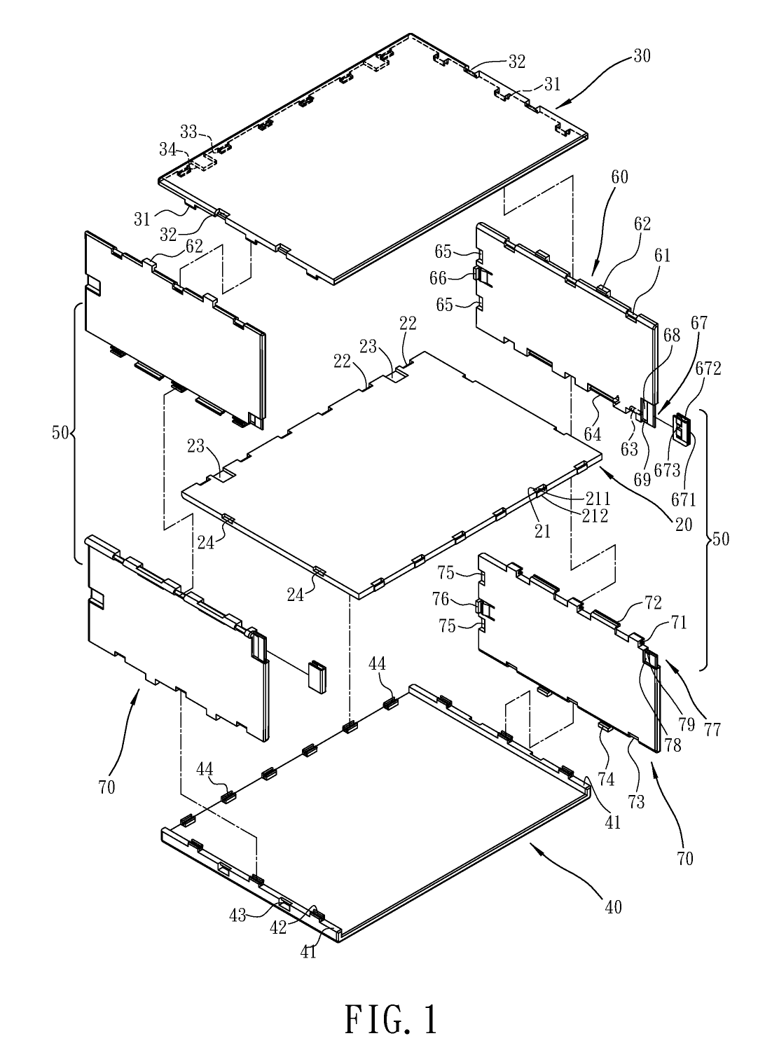

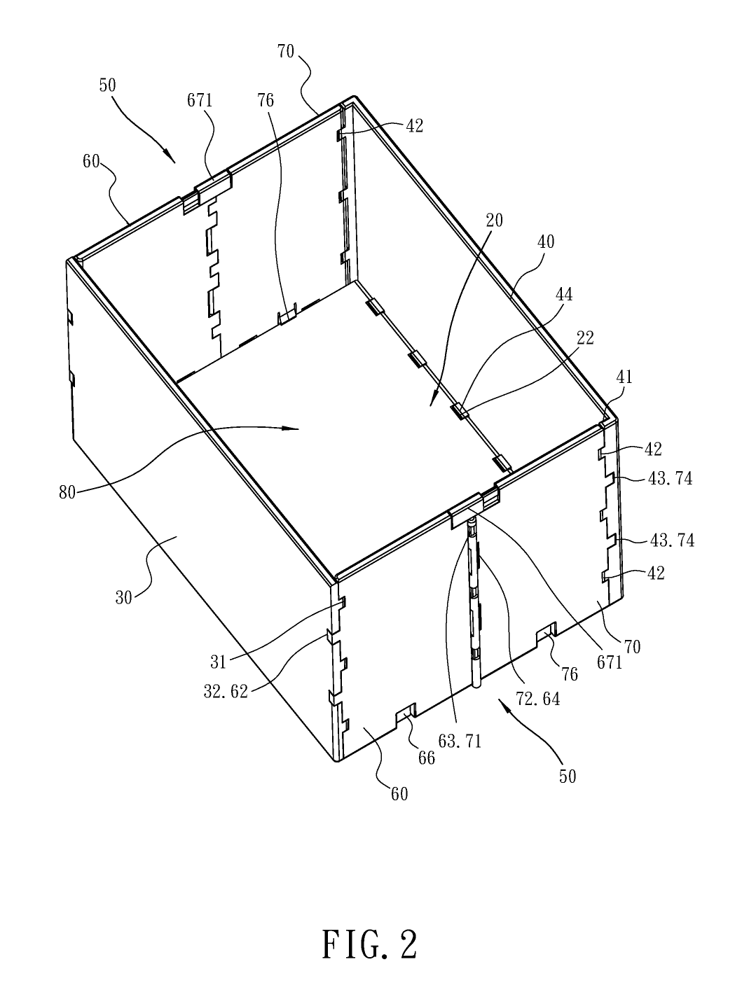

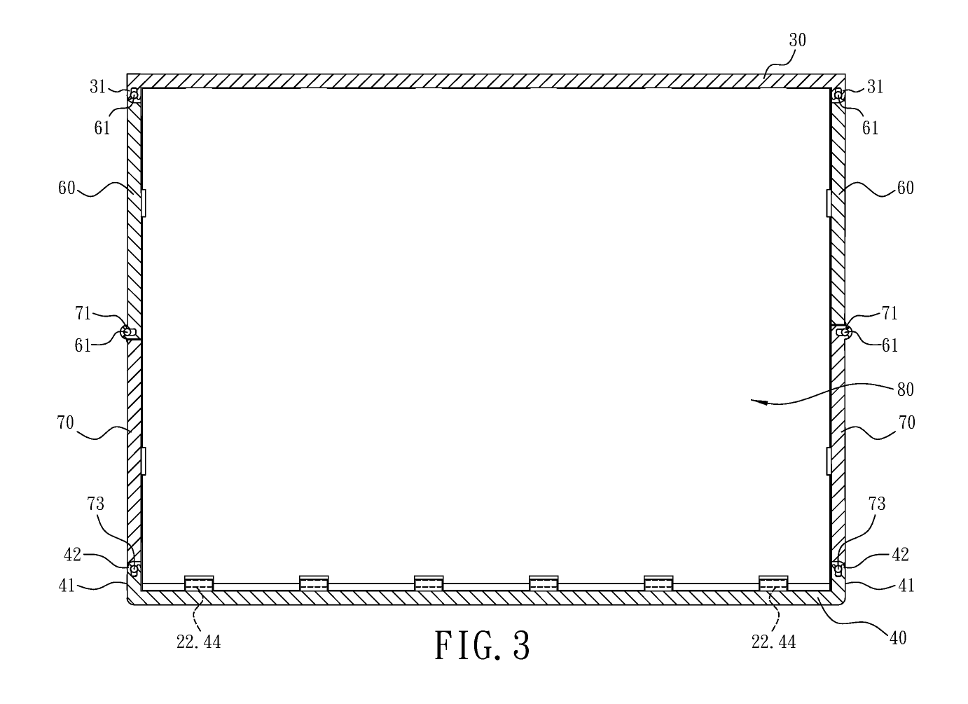

With reference to FIGS. 1-3, a collapsible storage box according to a preferred embodiment of the present invention comprises: a bottom plate 20, a first long plate 30, a second long plate 40, and two foldable short plates 50.

Each of the two foldable short plates 50 includes a first connection sheet 60 and a second connection sheet 70.

A front end of the bottom plate 20 retains with multiple first L-shaped hooks 33 on a bottom of the first long plate 30, multiple first rotary shafts 22 on a rear end of the bottom plate 20 rotatably connect with multiple first retainers 44 on a bottom of the second long plate 40 respectively. A first side of the bottom plate 20 retains with a first flexible hook 66 on a bottom of the first connection sheet 60 of each foldable short plate 50, and a second side of the bottom plate 20 retains with a second flexible hook 76 on a bottom of the second connection sheet 70 of each foldable short plate 50. The bottom plate 20 includes multiple locking recesses 21 defined on the front end thereof, the multiple first rotary shafts 22 arranged on the rear end of the bottom plate 20, multiple first notches 23 arranged among the multiple first rotary shafts 22 respectively, and multiple first cutouts 24 formed on the first side and the second sides of the bottom plate 20, wherein each of the multiple locking recesses 21 has an internal fence 211, a size of a bottom of which is less than that of a top of the internal fence 211, and each locking recess 21 further has a protrusion 212 formed on an outer wall of each locking recess 21.

The first long plate 30 includes multiple second retainers 31 arranged on a first side and a second side thereof individually, multiple second cutouts 32 defined among the multiple second retainers 31 respectively, the multiple first L-shaped hooks 33 formed on the bottom of the first long plate 30, and multiple second notches 34 defined among the multiple first L-shaped hooks 33 individually.

The second long plate 40 includes two ribs 41 arranged on a first side and a second side thereof individually, multiple third retainers 42 arranged on the two ribs 41 respectively, multiple L-shaped recesses 43 defined among the multiple third retainers 42 individually, and the multiple first retainers 44 formed on the bottom of the second long plate 40.

Each foldable short plate 50 includes the first connection sheet 60 and the second connection sheet 70, and the two foldable short plates 50 correspond to each other.

The first connection sheet 60 includes multiple second rotary shafts 61 arranged on a first side thereof, multiple second L-shaped hooks 62 formed among the multiple second rotary shafts 61 respectively, multiple third rotary shafts 63 arranged on a second side of the first connection sheet 60, multiple third notches 64 defined among the multiple third rotary shafts 63 individually, two fourth notches 65 formed on the bottom of the first connection sheet 60, the first flexible hook 66 defined between the two fourth notches 65, a first coupling seat 67 formed on a corner of a top of the first connection sheet 60 adjacent to the second connection sheet 70, a first indentation 68 defined on a bottom of the first coupling seat 67, and a first shoulder 69 formed on a front end of the first indentation 68, wherein the first coupling seat 67 has a U-shaped abutting piece 671, a slip 672 defined inside the U-shaped abutting piece 671, an engaging dent 673 formed in the slip 672.

The second connection sheet 70 includes multiple fourth retainers 71 arranged on a first side thereof adjacent to the second side of the first connection sheet 60, multiple third L-shaped hooks 72 defined among the multiple fourth retainers 71 individually, multiple fourth rotary shafts 73 arranged on a second side of the second connection sheet 70, multiple fourth L-shaped hooks 74 formed among the multiple fourth rotary shafts 73 respectively, two fifth notches 75 formed on the bottom of the second connection sheet 70, the second flexible hook 76 defined between the two fifth notches 75, a second coupling seat 77 formed on a corner of a top of the second connection sheet 70 adjacent to the first connection sheet 60, a second indentation 78 defined on a bottom of the second coupling seat 77, and a second shoulder 79 formed on a front end of the second indentation 78.

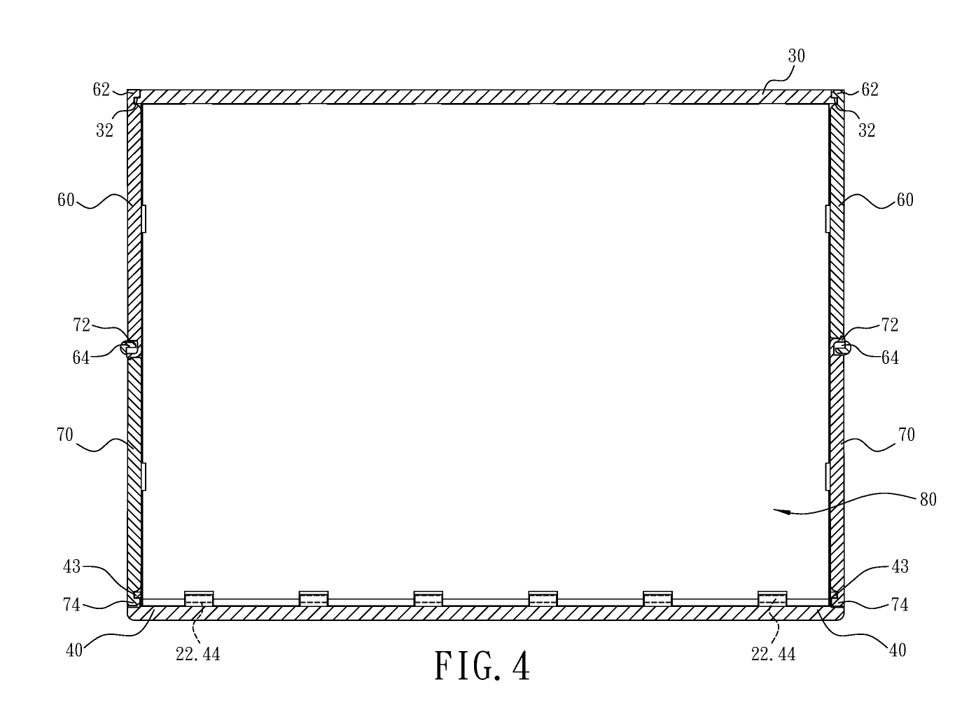

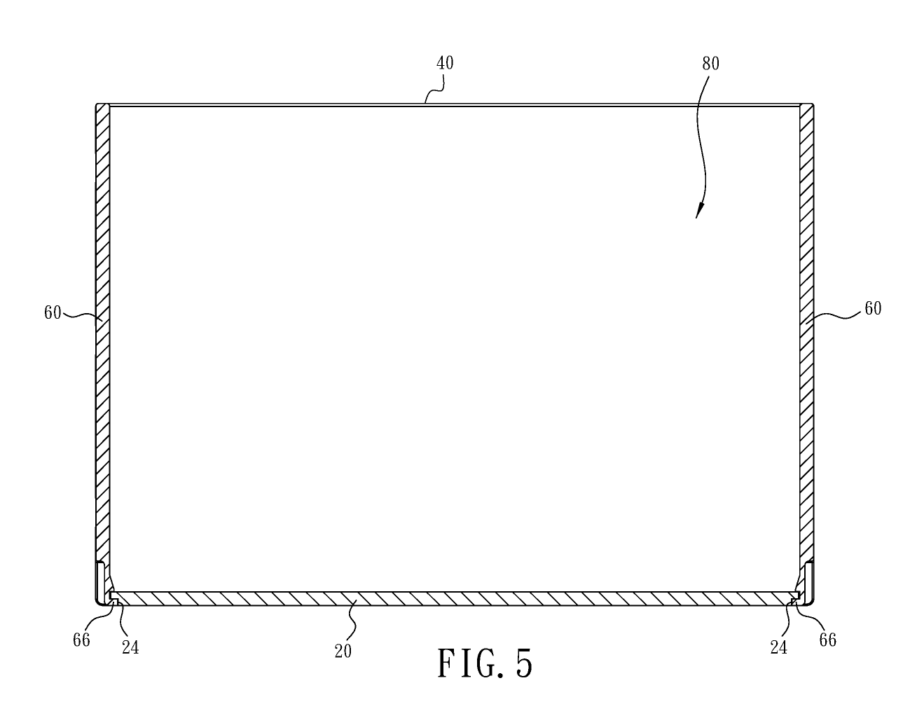

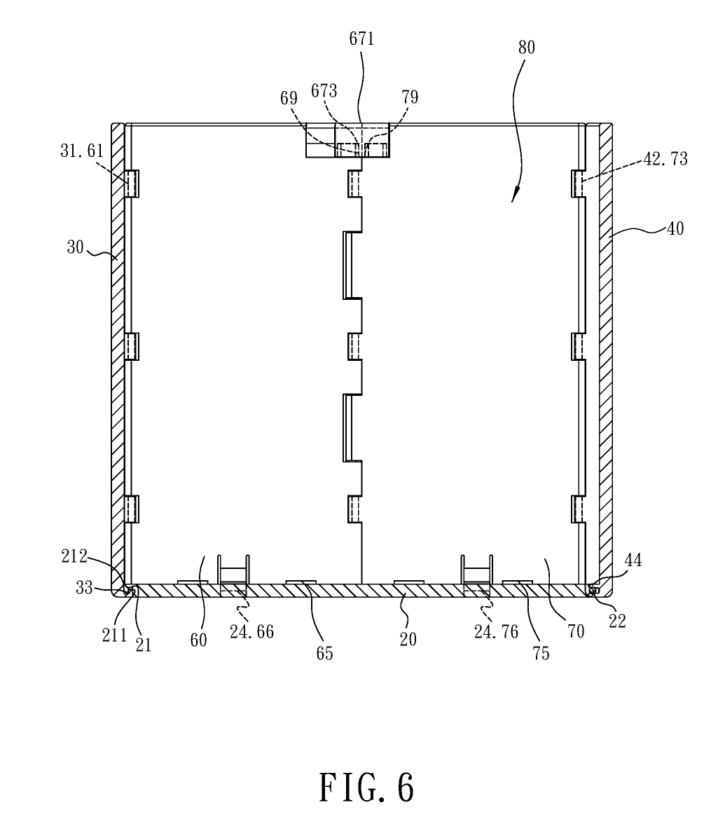

Referring to FIGS. 1-6, when expanding the collapsible storage box, the front end of the bottom plate 20 retains with the bottom of the first long plate 30, the multiple first rotary shafts 22 of the bottom plate 20 retain with the multiple third retainers 42 of the second long plate 40, the first side of the bottom plate 20 retains with the bottom of the first connection sheet 60 of each foldable short plate 50, the second side of the bottom plate 20 retains with the bottom of the second connection sheet 70 of each foldable short plate 50, hence the bottom plate 20, the first long plate 30, the second long plate 40, and each foldable short plate 50 define an accommodation chamber 80. Thereafter, when the engaging dent 673 of the first coupling seat 67 retains with the first shoulder 69, the first connection sheet 60 of each foldable short plate 50 is connected with the second connection sheet 70 of each foldable short plate 50 at 180 degrees, and the U-shaped abutting piece 671 of the first coupling seat 67 fixes each foldable short plate 50 so that each foldable short plate 50 does not retract inward to the accommodation chamber 80.

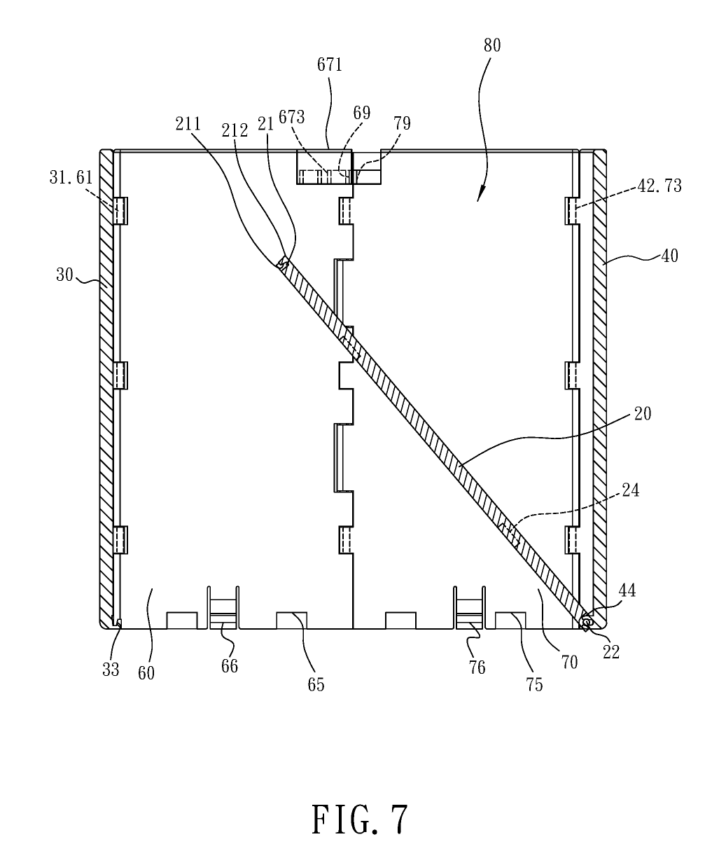

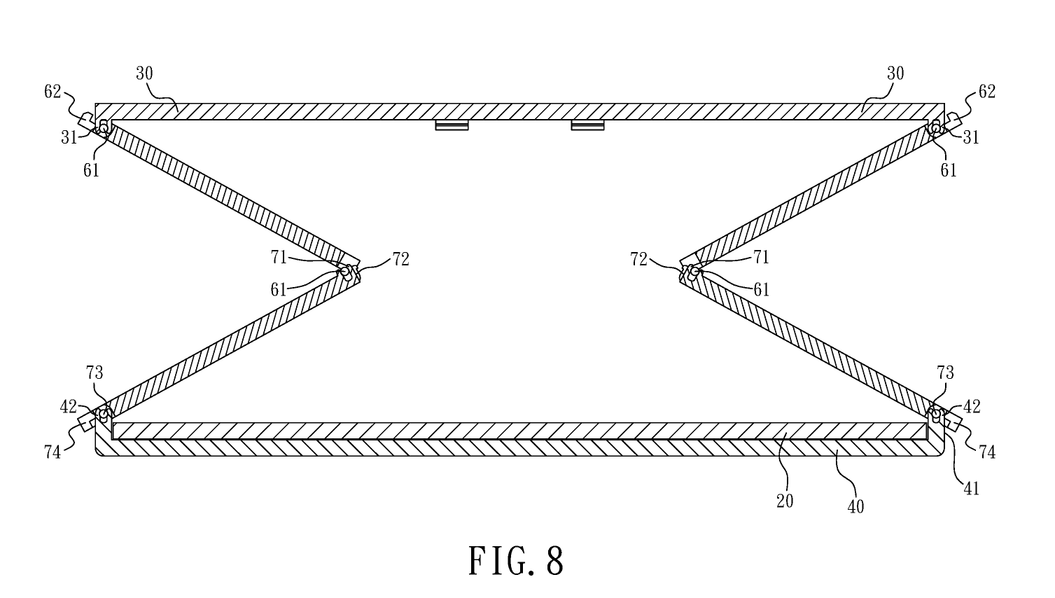

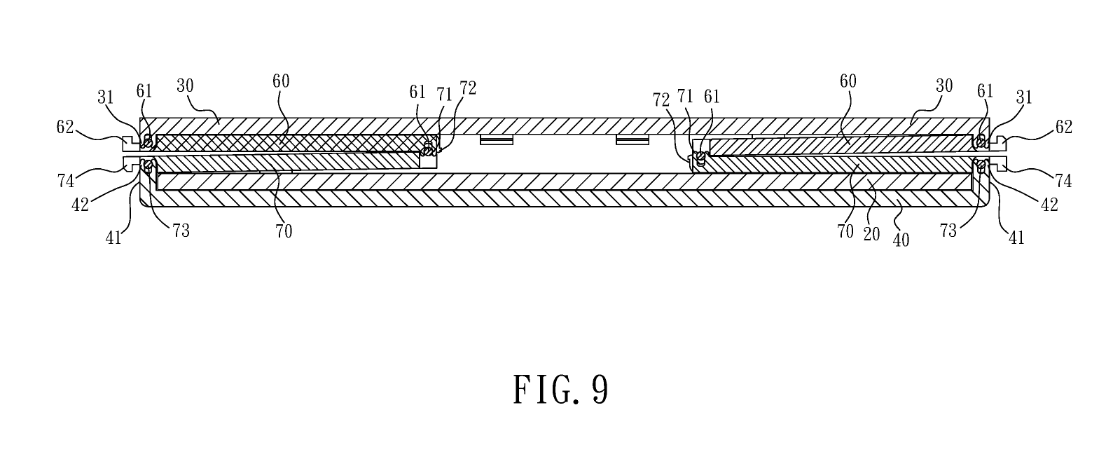

As shown in FIGS. 7-9, when retracting the collapsible storage box, the bottom plate 20 is lifted upward to the accommodation chamber 80 so that the two ribs 41 of the second long plate 40 stacks with the bottom plate 20, thereafter the U-shaped abutting piece 671 of the first coupling seat 67 is pushed to the first shoulder 69 so that each foldable short plate 50 is retracted to the accommodation chamber 80, thus retracting the collapsible storage box quickly and easily.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A collapsible storage box comprising: a bottom plate, a first long plate, a second long plate, and two foldable short plates;
each of the two foldable short plates including a first connection sheet and a second connection sheet;
wherein a front end of the bottom plate retains with multiple first L-shaped hooks on a bottom of the first long plate, multiple first rotary shafts on a rear end of the bottom plate rotatably connect with multiple first retainers on a bottom of the second long plate respectively, a first side of the bottom plate retains with a first flexible hook on a bottom of the first connection sheet of each foldable short plate, and a second side of the bottom plate retains with a second flexible hook on a bottom of the second connection sheet of each foldable short plate;
wherein the bottom plate includes multiple locking recesses defined on the front end thereof, the multiple first rotary shafts arranged on the rear end of the bottom plate, multiple first notches arranged among the multiple first rotary shafts respectively, and multiple first cutouts formed on the first side and the second sides of the bottom plate;
wherein the first long plate includes multiple second retainers arranged on a first side and a second side thereof individually, multiple second cutouts defined among the multiple second retainers respectively, the multiple first L-shaped hooks formed on the bottom of the first long plate, and multiple second notches defined among the multiple first L-shaped hooks individually;
wherein the second long plate includes two ribs arranged on a first side and a second side thereof individually, multiple third retainers arranged on the two ribs respectively, multiple L-shaped recesses defined among the multiple third retainers individually, and the multiple first retainers formed on the bottom of the second long plate;
wherein each foldable short plate includes the first connection sheet and the second connection sheet, and the two foldable short plates correspond to each other;
wherein the first connection sheet includes multiple second rotary shafts arranged on a first side thereof, multiple second L-shaped hooks formed among the multiple second rotary shafts respectively, multiple third rotary shafts arranged on a second side of the first connection sheet, multiple third notches defined among the multiple third rotary shafts individually, two fourth notches formed on the bottom of the first connection sheet, the first flexible hook defined between the two fourth notches, a first coupling seat formed on a corner of a top of the first connection sheet adjacent to the second connection sheet, a first indentation defined on a bottom of the first coupling seat, and a first shoulder formed on a front end of the first indentation, wherein the first coupling seat has a U-shaped abutting piece, a slip defined inside the U-shaped abutting piece, an engaging dent formed in the slip;
wherein the second connection sheet includes multiple fourth retainers arranged on a first side thereof adjacent to the second side of the first connection sheet, multiple third L-shaped hooks defined among the multiple fourth retainers individually, multiple fourth rotary shafts arranged on a second side of the second connection sheet, multiple fourth L-shaped hooks formed among the multiple fourth rotary shafts respectively, two fifth notches formed on the bottom of the second connection sheet, the second flexible hook defined between the two fifth notches, a second coupling seat formed on a corner of a top of the second connection sheet adjacent to the first connection sheet, a second indentation defined on a bottom of the second coupling seat, and a second shoulder formed on a front end of the second indentation.

2. The collapsible storage box as claimed in claim 1, wherein the bottom plate, the first long plate, the second long plate, and each foldable short plate define an accommodation chamber.

3. The collapsible storage box as claimed in claim 1, wherein when the bottom plate is lifted upward to the accommodation chamber, the two ribs of the second long plate stacks with the bottom plate.

4. The collapsible storage box as claimed in claim 1, wherein each of the multiple locking recesses has an internal fence, a size of a bottom of which is less than that of a top of the internal fence, and each locking recess further has a protrusion formed on an outer wall of each locking recess.

5. The collapsible storage box as claimed in claim 1, wherein when the engaging dent of the first coupling seat retains with the first shoulder, the first connection sheet of each foldable short plate is connected with the second connection sheet of each foldable short plate at 180 degrees.
